(19) United States
(12) Patent Application Publication
(10) Pub. No.: US 2026/0187148 A1
(43) Pub. Date: Jul. 2, 2026

(54) METHOD AND SYSTEM FOR IMPLEMENTING RETRIEVAL AUGMENTED GENERATION WITH IMPROVED CONTEXT IDENTIFICATION FROM SEMI-STRUCTURED DOCUMENTS

(71) Applicant: LTI Mindtree Ltd, Mumbai (IN)

(72) Inventors: Brijesh Prabhakar, Mumbai (IN); ChandiPrasad Ojha, Mumbai (IN); Sibin Kunnumpurath James, Mumbai (IN)

(21) Appl. No.: 19/097,881

(22) Filed: Apr. 2, 2025

(30) Foreign Application Priority Data
Dec. 30, 2024 (IN) 202421104454

(51) Int. Cl. G06F 16/835; G06F 16/838; G06F 40/30

(52) U.S. Cl. CPC G06F 16/8373; G06F 16/838; G06F 40/30

(57) ABSTRACT

Method and system for implementing RAG with improved context identification from semi-structured documents is disclosed. A target document is preprocessed by segmenting into individual pages. Text content from each individual page is extracted and processed through a domain-specific token filter to identify terms matching a stored domain-specific dictionary, and generate filtered page content comprising the matching terms. A page vector representation of the filtered page is computed, and vector similarity is performed between each page vector representation and stored vectors in a vector database that are associated with predefined entity types via entity labels that are extracted from matched templates. The entity labels are mapped to corresponding document pages based on similarity scores. A user query is analyzed using a Large Language Model (LLM) to identify relevant entity labels and pages with the relevant entity labels to generate a response.

### FIELD

Various embodiments of the present disclosure relate to information retrieval. More particularly, the present disclosure relates to a method and system for implementing retrieval augmented generation with improved context identification from semi-structured documents.

### BACKGROUND

In recent years, Generative AI (GenAI) solutions have emerged as transformative tools for addressing complex business and engineering challenges. At the heart of these solutions are Large Language Models (LLMs), which are trained on extensive datasets to understand and generate human-like text. However, despite their capabilities, publicly available LLMs are inherently limited in their applicability to specific business scenarios. Enterprises cannot rely solely on the generalized knowledge base of these models, as effective problem-solving often requires incorporating highly contextual and domain-specific information.

Contextual data, which must be provided to the LLMs along with the task, can come from various sources and exist in multiple formats. Structured data, typically stored in databases, is relatively straightforward to retrieve and process. However, unstructured or semi-structured data, often found in diverse document formats such as invoices, contracts, or reports, poses a greater challenge. Extracting meaningful text from such semi-structured documents is a critical requirement for enabling LLMs to perform tasks effectively within specific business contexts.

LLMs operate within defined context limits, typically ranging from 4,000 to 2 million tokens, depending on the specific model. This constraint presents significant challenges when working with large knowledge bases created from unstructured data, as their size often exceeds these token limits. To address this limitation, solutions like Retrieval-Augmented Generation (RAG) have been developed, offering several key benefits including: enabling the use of smaller context size LLMs with large knowledge bases, minimizing costs through optimized token usage, improving accuracy by reducing context-related hallucinations, and enhancing overall performance through efficient context management.

RAG enables LLMs to operate efficiently by introducing a retrieval mechanism that dynamically identifies and extracts only the most relevant context from the knowledge base. This is achieved by segmenting the content into manageable chunks and employing similarity search methods, such as vector-based or semantic matching, to retrieve content most pertinent to the task at hand. By sending only relevant information to the LLM, RAG not only optimizes the use of limited context but also enhances the accuracy and relevance of the LLM's output.

However, the effectiveness of RAG and similar approaches heavily depends on the quality of context retrieval, which presents significant challenges in current implementations. A critical limitation is the consistently low recall accuracy for shorter search queries, particularly when processing semi-structured documents. The extraction process itself is often time-consuming and costly, requiring expensive processing of entire documents when only specific sections contain relevant information. Additionally, current implementations lack mechanisms for training and self-improvement through feedback loops, necessitating complete manual verification of outputs.

While numerous RAG and advanced RAG approaches have been developed, theoretically aiming to improve the precision and recall of context retrieval, practical implementations often fall short of these expectations. A significant challenge in the existing solutions is the failure to retrieve relevant chunks from the knowledge base due to shortcomings in similarity search techniques. This issue often results in the retrieval of irrelevant chunks, which dilutes the quality of the context sent to the LLM and increases the risk of providing incomplete or misleading information in the response.

Moreover, such retrieval inefficiencies bloat the LLM's context window, consuming valuable token space that could otherwise be allocated to relevant and task-specific data. This not only undermines the benefits intended by the RAG implementation but also leads to degraded performance and accuracy of the LLM. The processing of unnecessary pages further increases computational complexity and operational costs.

The aforementioned approaches rely primarily on matching the search text against a large collection of vectorized chunks derived from the knowledge base. The methods employ similarity search techniques, such as cosine similarity or nearest-neighbor algorithms, to retrieve chunks that appear semantically related to the search text. However, a critical limitation of these methods is the absence of a mechanism to match the search text against an absolute truth reference chunk or to incorporate learned patterns from previously successful retrievals. This lack of a reference framework means current systems cannot effectively leverage historical successes or verify the accuracy of retrieved chunks relative to user intent.

To address the challenges of inaccurate chunk retrieval, existing approaches incorporate AI enrichment techniques, which enhances the utility of the knowledge base by generating additional metadata for each chunk. Metadata, such as summaries, captions, or keywords, is produced by processing the chunk through the LLM and then appending this information to the database. However, these enrichment steps increase preprocessing time and computational costs without proportionally improving retrieval quality.

Current retrieval processes leverage multiple advanced search techniques to identify relevant chunks. These include dense vector-based methods, such as semantic search, which capture nuanced contextual relationships; sparse vector techniques, such as BM25 and SPLADE, which focus on term frequency and relevance scoring; and full-text search for keyword-based matching. Additionally, hybrid search approaches combine dense and sparse methods to harness the strengths of both, aiming to deliver a more precise retrieval mechanism.

While these techniques represent a significant evolution in improving chunk relevance, the effectiveness of such systems still heavily depends on the quality of the metadata generated and the ability of the search algorithms to effectively utilize both the original content and its enriched metadata. Furthermore, current implementations lack robust confidence scoring mechanisms, making it difficult to assess the reliability of retrieved content without extensive manual verification.

Therefore, in order to address the above-mentioned challenges, there is a need for enhanced methods for text extraction, context chunking, and similarity assessment to ensure only the most pertinent information is retrieved and utilized. The existing deficiencies also highlight the need for mechanisms that incorporate reference-based validation, truth-matching techniques, and feedback-driven learning capabilities to improve the overall efficacy of RAG-based implementations while reducing the necessity for manual verification.

### SUMMARY

The present disclosure provides a method and system for implementing RAG with improved context identification from semi-structured documents is disclosed. A target document is preprocessed by segmenting into individual pages. Text content from each individual page is extracted and processed through a domain-specific token filter to identify terms matching a stored domain-specific dictionary, and generate filtered page content comprising the matching terms. A page vector representation of the filtered page is computed, and vector similarity is performed between each page vector representation and stored vectors in a vector database that are associated with predefined entity types via entity labels that are extracted from matched templates. The entity labels are mapped to corresponding document pages based on similarity scores. A user query is analyzed using a Large Language Model (LLM) to identify relevant entity labels and pages with the relevant entity labels to generate a response.

One or more advantages of the prior art are overcome, and additional advantages are provided through the disclosure. In addition to illustrative aspects, embodiments, and features described above, further aspects, embodiments, and features will become apparent by reference to drawings and following detailed description.

### BRIEF DESCRIPTION OF THE FIGURES

FIG. 1 is a diagram that illustrates an exemplary environment 100 within which various embodiments of the present disclosure may function.

FIG. 2 is a diagram that illustrates a system 106 for implementing a Retrieval-Augmented Generation (RAG) with improved context identification from semi-structured documents, in accordance with an embodiment of the present disclosure.

FIG. 3 is a diagram that illustrates a flowchart 300 for a method for implementing a Retrieval-Augmented Generation (RAG) solution with improved context identification from semi-structured documents, in accordance with an embodiment of the present disclosure.

### DESCRIPTION

Pursuant to various embodiments of the present disclosure, the method and system implements a Retrieval-Augmented Generation (RAG) solution using improved identification of relevant text from semi-structured documents. A target document and a user query is received to initiate text extraction operations from the target document, which is preprocessed by segmenting into individual pages, and extracting text that is processed through a domain-specific token filter to identify terms matching a stored domain-specific dictionary, and generate filtered page content with matching terms. A page vector representation of the filtered page is computed using an embedding model, and vector similarity is performed between each page vector representation and stored vectors in a vector database that are associated with predefined entity types via entity labels that are extracted from matched templates. The entity labels are mapped to corresponding document pages based on similarity scores. A user query is analyzed using a Large Language Model (LLM) to identify relevant entity labels and pages with the relevant entity labels to generate a response.

In one or more embodiments, the semi-structured documents refer to documents that do not follow a rigid data model yet contain organizational elements that provide partial structure. The semi-structured documents usually combine freeform text with structured components such as tables, headers, footers, or metadata fields. Examples of semi-structured documents include invoices, purchase orders, contracts, medical reports, financial statements, resumes, and log files.

In one or more embodiments, text extraction refers to the process of identifying, isolating, and retrieving meaningful textual content from documents, particularly those with semi-structured formats. The process involves analyzing the document to locate specific data elements embedded within the structure, such as text fields, tables, labels, or annotations, and converting them into a human-readable text format suitable for further processing.

In one or more embodiments, a user query refers to a request or input provided by a user to retrieve specific information or insights from a knowledge base, system, or document. The query can take various forms, such as natural language questions, keywords, or structured commands, depending on the interface and functionality of the system.

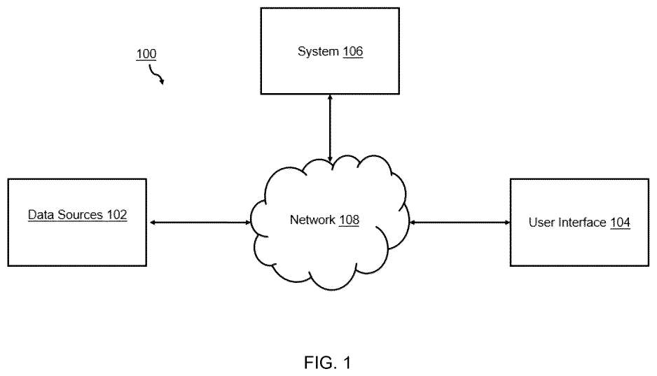

FIG. 1 is a diagram that illustrates an exemplary environment 100 within which various embodiments of the present disclosure may function. Referring to FIG. 1, the environment 100 comprises one or more data sources 102, a user interface (UI) 104, a system 106, and a network 108.

The one or more data sources 102 refers to repositories or storage locations that contain or provide access to the target documents. The one or more data sources 102 can include, but are not limited to, databases, document management systems, cloud storage platforms, or file systems, where structured, semi-structured, or unstructured documents are stored. The target documents may include various types of semi-structured data, such as invoices, contracts, medical records, or reports, which are utilized in the text extraction process.

In some non-limiting embodiments, the one or more data sources 102 can be located at local or remote locations. Local data sources may include on-premises databases, file systems, or document storage systems that are physically located within the same network or infrastructure as the system. Remote data sources, on the other hand, may include cloud-based storage services, distributed databases, or external repositories that are accessible over a network. These data sources, whether local or remote, serve as the origin for retrieving the target documents, providing flexibility in how and where the documents are stored and accessed for subsequent text extraction and processing.

The UI 104 refers to a component that allows users to interact with the environment and initiate tasks, such as submitting queries or managing documents. The UI 104 can be a graphical interface (GUI), a command-line interface (CLI), or a voice-based interface, depending on the system's design. It provides the users with tools to input information, view outputs, and navigate through the available functionalities. Accordingly, the UI 104 enables the users to submit queries related to the target documents, interact with the one or more data sources 102, and visualize the results of the text extraction process.

In one or more embodiments, the UI 104 is also configured to present responses to the users by calling LLM with the content of the document pages containing identified labels along with user query to generate the responses. The presented responses allow the users to view, analyze, and interact in a clear and understandable format.

The system 106 implements a method to detect the correct page or section in a semi-structured document that is most likely to contain the answer to a given query/question, based on the historical success of retrieving answers from similar documents. The system 106 learns to identify one or more sections of a document that provide a relevant context for a search text and stores this information in an embedding database. The document preprocessing steps involve identifying each relevant section in the document by comparing each section against the embeddings stored in the database. Once an appropriate section is identified, it is labeled with a section title, which can be used to retrieve the section when a search text or query is received.

The network 108 includes communication networks operable to facilitate communication, either wirelessly or wired. The network 108 connects a plurality of computer systems. The network 108 may comprise, for example, an intranet, local area network, wide area network, the internet, public switched telephone network (PSTN), network of networks, or other networks.

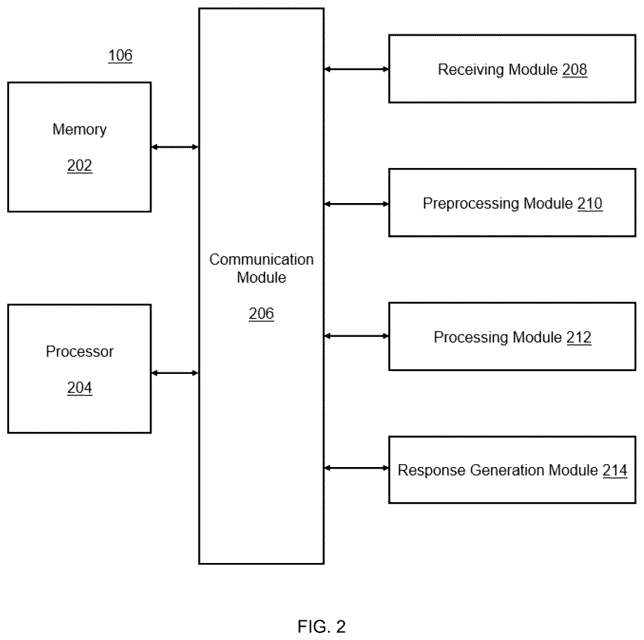

FIG. 2 is a diagram that illustrates the system 106 for implementing a Retrieval-Augmented Generation (RAG) with improved context identification from semi-structured documents, in accordance with an embodiment of the disclosure. Referring to FIG. 2, the system 106 includes a memory 202, a processor 204, a communication module 206, a receiving module 208, a preprocessing module 210, a processing module 212, and a response generation module 214.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 106 in accordance with various aspects of the present disclosure. The processor 204 may be further configured to communicate with various modules of the system 106 via the communication module 206.

The receiving module 208 may comprise suitable logic, code, and/or interfaces that may be configured to receive a target document and a user query to initiate the process of identification of relevant text from the target document. The target document could be a semi-structured stored in a local or remote data source, and the user query refers to a request for specific information or insights from the target document.

In one or more embodiments, upon receiving the inputs, the receiving module 208 processes the target document and the user query. The receiving module 208 may include various interfaces to support multiple input methods, such as a graphical user interface (GUI) or an application programming interface (API), allowing users or other system components to submit their requests.

The preprocessing module 210 may comprise suitable logic, code, and/or interfaces that may be configured to preprocess the target document by performing segmentation of the target document, and extracting text content from each individual page of the target document upon segmentation.

In one or more embodiments, segmentation involves dividing the target document into smaller, coherent sections or pages based on predefined criteria, such as page breaks, headings, or content structure. After segmentation, the preprocessing module 210 extracts the text content from each segment, isolating the textual data for analysis.

In one or more embodiments, extracting the text content from each individual page of the target document (upon segmentation) involves processing the extracted text content through a domain-specific token filter to identify terms matching a stored domain-specific dictionary, and generate filtered page content comprising the matching terms. This filtering process effectively removes dynamic or variable content while retaining domain-relevant information, enabling more accurate template matching in subsequent steps.

In one or more embodiments, the domain-specific dictionary is generated by analyzing the plurality of training documents using the LLM to identify domain-specific terms, aggregating the identified domain-specific terms, and storing the aggregated terms in the domain-specific dictionary.

In one or more embodiments, the plurality of training documents relevant to a specific domain are analyzed using the LLM to understand the context and content of the training documents, identifying terms and phrases that are frequently used within the domain.

Once the LLM identifies domain-specific terms from the training documents, the terms are aggregated to create a list. The aggregation process may include removing duplicates, normalizing variations of the same term (e.g., singular and plural forms), and ranking terms based on their relevance or frequency within the domain.

In one or more embodiments, the aggregated domain-specific terms are stored in a structured format within the domain-specific dictionary. The storage mechanism is configured to facilitate efficient lookups and integration with the token filtering processes. The domain-specific dictionary may also be periodically updated or expanded as new training documents are analyzed or as the domain evolves.

In one or more embodiments, upon generating the filtered page content, a page vector representation of the filtered page content is computed by transforming the filtered text into a numerical representation that encapsulates the semantic meaning of the content. Document embedding techniques may be used to compute the page vector representation.

In some non-limiting embodiments, the vector representations are generated using pre-trained models or fine-tuned embeddings tailored to the specific domain, enabling efficient comparison and retrieval during subsequent operations. Alternatively, the use of a domain filter eliminates the need for fine-tuning embedding models, enabling easier solution tuning by simply refreshing the domain-specific terms

[symbol]

In one or more embodiments, the preprocessing module 210 performs vector similarity computation between each page vector representation and stored template vectors in the vector database. Techniques such as cosine similarity, Euclidean distance, or other similarity metrics may be employed to determine the degree of matching between document pages and stored templates, with each template vector being associated with predefined entity types via entity labels.

In one or more embodiments, each stored template vector is associated with predefined entity types via corresponding entity labels. The entity labels serve as metadata that categorically define the type of information or concept represented by the template vector. By linking template vectors to entity labels, the preprocessing module 210 establishes a structured relationship between the vector representations and their semantic meanings. This labeling approach enables precise mapping between document content and extractable information types, facilitating accurate information retrieval during query processing.

In one or more embodiments, the stored template vectors in the vector database are generated by receiving a plurality of training documents of a specific domain that follows common document structure. These training documents share consistent layouts, sections, and information organization patterns characteristic of the domain.

The generation of template vectors involves two key phases: initial template creation and template refinement. In the initial phase, domain experts manually identify representative pages from training documents and assign appropriate entity labels. In the refinement phase, these initial templates are improved through comparison with additional training documents, where experts verify matches and help identify dynamic content.

The training process begins with a user manually identifying important pages from the training documents. For each identified page, the user assigns entity labels that describe the types of information contained on that page. This manual selection and labeling process is crucial as it allows domain experts to indicate which pages contain valuable information and what type of information can be found on those pages.

The preprocessing module 210 segments each training document into individual pages. The segmentation process divides the training documents into discrete, manageable units, such as pages or sections, based on predefined criteria such as page breaks, headings, or logical content boundaries.

For each manually selected page, the preprocessing module 210 extracts the text content and processes it through a domain-specific token filter. This filtering process identifies terms that match a predefined domain-specific dictionary, retaining only the relevant domain-specific terminology while removing unnecessary text. The filtered content undergoes transformation using document embedding technique to create an initial template vector.

The initial template vector is then used to identify potential matching pages in subsequent training documents. Since these initial matches may contain dynamic content that varies between documents, the system presents a list of potential matching pages to the user. The user manually confirms which pages are correct matches, ensuring accurate template refinement.

Once matching pages are confirmed by the user, the preprocessing module 210 analyzes these pages to identify dynamic content that varies across instances while maintaining the same semantic meaning. By comparing multiple confirmed matching pages, the system identifies which content elements are dynamic (such as specific dates, names, or numerical values) versus static structural elements that remain consistent.

In one or more embodiments, after domain-specific filtering, the preprocessing module 210 may be configured to compute template vectors by retaining only the static structural elements and domain-specific terms, while removing the identified dynamic content. These template vectors, along with their user-assigned entity labels, are stored in the vector database. The entity labels serve as metadata, categorizing each template vector with specific, meaningful descriptors that define the type of information the vector represents.

In one or more embodiments, the preprocessing module 210 may be further configured to optimize the stored template vectors through an iterative process of identifying and removing dynamic content within the training pages. This optimization process begins with training pages that share the same entity labels previously assigned by the user during the manual training phase. By focusing on pages that the user has identified as functionally similar through their label assignments, the system ensures that the optimization occurs on truly comparable content.

In one or more embodiments, the preprocessing module 210 compares filtered content across these training pages that share user-assigned entity labels. Through this comparison, the system identifies dynamic content—terms or phrases that vary from page to page while maintaining the same semantic meaning. For example, in pages labeled as “policy declarations” by the user, elements such as policy numbers, dates, or monetary amounts would be identified as dynamic content since they change between documents while serving the same functional purpose.

By removing these identified dynamic content elements while preserving the static structural content and maintaining the user-assigned entity labels, the system creates more stable and accurate template representations. This selective removal process ensures that the templates retain their functional context while becoming more robust for matching operations.

Once dynamic content is identified and removed, the preprocessing module 210 regenerates the template vectors using only the retained static structural content. These regenerated template vectors, derived from content that has been filtered to exclude both non-domain-specific terms and dynamic content, provide more precise matching patterns. The optimization results in template vectors that better represent the essential structure and domain-specific elements of each document type, improving the accuracy of subsequent matching operation.

In one or more embodiments, the user query is analyzed to identify one or more relevant entity labels from a list of entity labels that are associated with the target document, which can answer the user query.

In one or more embodiments, upon performing vector similarity computation, the preprocessing module 210 extracts the entity labels from matched templates. The entity labels are then mapped to the corresponding document pages based on the computed similarity scores between the page vector representations and the stored template vectors.

In one or more embodiments, the similarity score for a page is determined by computing the cosine similarity between the filtered page vector representation of the target document and each stored template vector in the vector database. Cosine similarity measures the angular distance between two vectors in a multidimensional space, providing a numerical value that indicates how closely the vectors align.

For each filtered page vector representation, the preprocessing module 210 computes its cosine similarity with all available template vectors. Among the computed values, the highest cosine similarity value is selected as the similarity score for the page, which indicates the degree of alignment between the page's content and the closest matching template, reflecting how well the page's textual content corresponds to the predefined entity labels and structure of the template.

In one or more embodiments, individual pages requiring enhanced text extraction are identified based on their assigned entity labels. The system 106 determines which pages need enhanced processing by analyzing special processing labels mapped during the template matching phase. This label-based approach ensures that specialized processing is applied based on the type of information expected on each page.

For the identified pages, the system applies label-specific extraction rules to refine the text content. These rules specify both the types of enhanced extraction techniques to be applied and the extraction parameters specific to each entity label. For example, pages labeled as containing tabular financial data might trigger specialized table extraction techniques, while pages labeled as containing policy endorsements might activate enhanced OCR settings optimized for complex layouts.

In one or more embodiments, the label-specific extraction rules are defined based on the characteristics and requirements of different entity types. These rules may specify various extraction parameters such as OCR sensitivity, parsing algorithms, or specialized filtering steps, each tailored to the specific type of information indicated by the entity label. The refined text content obtained through this enhanced extraction process maintains higher accuracy for complex document sections while optimizing processing resources by applying enhanced extraction only where needed based on entity labels.

In one or more embodiments, the label-specific extraction rules incorporate carrier-specific and line-of-business-specific processing requirements. For pages assigned specific pre-processing labels, the system applies these domain-specific rules to modify entity extraction prompts, adjust similarity thresholds, and select appropriate extraction techniques. For example, different insurance carriers may require specific extraction approaches for policy endorsements, or different lines of business may need specialized handling of coverage details.

In one or more embodiments, upon completing the vector similarity computation, the preprocessing module 210 extracts entity labels from the matched templates and maps these labels to corresponding document pages. This mapping process is driven by the computed similarity scores, where each page is associated with entity labels from its best-matching template. For instance, if a document page achieves a high similarity score with a template containing entity labels for “coverage amount” and “deductible”, these labels are mapped to that specific page, indicating the types of information that can be extracted from it. This label mapping creates a structured bridge between the document pages and their extractable information types, enabling precise targeting during subsequent query processing. The preprocessing module 210 maintains these mappings, associating each processed page with specific entity labels that describe the types of information present on that page based on matched templates.

The processing module 212 may comprise suitable logic, code, and/or interfaces configured to process the user query by leveraging advanced analysis techniques. Upon receiving the user query, the processing module 212 utilizes the LLM to analyze the query and identify relevant entity labels associated with the user's intent from a list of all available entity labels in the document. The LLM is presented with the list of all available entity labels in the document and is enabled to identify a relevant entity label for the user query. Additionally, the processing module 212 identifies matching templates for the target document based on maximum number of pages matched during the vector similarity computation for establishing a template context for query processing.

In one or more embodiments, the processing module 212 retrieves all entity labels associated with the target document. The processing module 212 then maps the user query against these retrieved entity labels using the LLM to determine which labels are specifically relevant for answering the query. Based on this mapping, the processing module 212 selects a plurality of pages from the document that contains these entity labels.

In one or more embodiments, the processing module 212 verifies whether at least one entity label and its corresponding page have been identified by the LLM. If no such identification is made, the processing module 212 transitions to a fallback processing phase.

During the fallback phase, the preprocessing module 210 computes a full-content vector representation for each page of the target document. Unlike the initial processing phase, where filtered content is prioritized for targeted and efficient search, the full-content vector representation encompasses all textual data from each page, providing a comprehensive basis for secondary matching.

Subsequently, the preprocessing module 210 performs a fallback vector similarity search using these full-content vector representations. The fallback vector similarity search leverages the embeddings created from the unfiltered textual data to identify additional relevant pages that might not have been captured in the initial template-based search phase, particularly useful when dealing with non-standard page formats or unique document structures.

Once the additional relevant pages are identified, the processing module 212 forwards them to the response generation module 214.

The response generation module 214 may comprise suitable logic, code, and/or interfaces configured to formulate a response to the user query by leveraging LLM and relevant pages from the document identified in the processing phase.

In one or more embodiments, a confidence score is computed to evaluate the closeness of the extracted page embedding to the matched template vectors. The confidence score is the cosine similarity score between the identified page and its matching template vector. Higher similarity scores reflect a stronger match between the page content and the expected structure, thereby enhancing confidence in the relevance of the extracted information.

In one or more embodiments, the computed confidence score, along with the generated response, is presented to the user via the UI 104. Both the response and the confidence score in a clear and user-friendly format are presented, enabling the user to assess the reliability of the provided information. This score specifically reflects the strength of template matching, providing users with direct insight into the system's confidence in its template-based extraction process.

In some non-limiting embodiments, the confidence score is displayed as a numerical value, percentage, or a visual indicator, such as a color-coded bar or rating system, to intuitively convey the level of confidence in the generated response. For example, a high confidence score might be represented by a green indicator, while a lower score could be displayed in yellow or red, signaling potential gaps in the extracted information.

In one or more embodiments, feedback from the user is received to indicate the accuracy of the generated response. The system 106 facilitates this feedback process through the UI 104, which provides an interactive mechanism for users to evaluate the response. The user feedback received on the system's 106 accuracy will be used by the backend team to analyze domain term dictionary, created page templates, and applied entity labels to make necessary changes so that the right template is matched for the user query.

In one or more embodiments, when the user feedback is received, the system 106 stores this feedback specifically against the matched template page, creating direct associations with multiple contextual elements, including the page vectors used for generating the response, the complete generated response text, and associated metadata such as timestamp and user identification. This structured storage approach ensures that feedback directly contributes to evaluating both template matching accuracy and entity label correctness, enabling systematic template improvement and validation.

In one or more embodiments, the confidence score is compared to a predefined confidence threshold for automatically triggering different response handling strategies. The predefined confidence threshold is dynamically adjustable and can be fine-tuned based on historical performance and domain-specific requirements.

In one or more embodiments, when the confidence score falls below the predetermined confidence threshold, the system 106 initiates a manual verification workflow. This workflow enables human oversight specifically for responses that may be uncertain or incomplete. A designated verifier is presented with a comprehensive verification package including the generated response, matched template details, and the specific document pages from which information was retrieved. The verifier can provide structured feedback through standardized forms, indicating specific areas of improvement needed in template matching, entity extraction, or response generation.

Once the verification input is received, it is stored in a structured format that captures both quantitative assessments and qualitative feedback. This structured storage includes specific verification decisions, correction details, and improvement suggestions, all linked to the original template matches. This verification data becomes a direct input for system refinement, enabling targeted improvements in template matching accuracy, entity label assignments, and extraction parameters. The manual feedback loop systematically enhances the system's ability to handle complex queries with higher accuracy, creating a clear path from verification to specific system improvements.

In one or more embodiments, the system 106 conducts regular analysis of stored user feedback patterns to identify template pages associated with consistent negative feedback. This systematic review examines feedback data across multiple instances to detect recurring issues, with particular attention to template matching accuracy and entity label correctness. Pages receiving repeated negative feedback are specifically flagged for template optimization.

Once pages with consistent negative feedback are identified, they undergo detailed analysis to pinpoint dynamic content that may have been inappropriately included in template vector representations. Dynamic content, such as dates, names, or other context-dependent terms, can significantly impact vector matching accuracy. The analysis specifically targets content variations across pages that share the same entity labels and layout structure, ensuring that only truly variable elements are identified.

In one or more embodiments, after identifying the dynamic content, the system initiates a template refinement process by removing these variable elements from the template vectors. This removal process is carefully executed to preserve the core, unchanging elements of the document while maintaining essential entity label associations. Each removed element is logged to ensure consistent treatment across similar templates, creating a systematic approach to dynamic content handling.

Once the dynamic content is removed, the system 106 regenerates the corresponding template vectors in the vector database. This regeneration process creates updated vector representations that reflect the refined content structure. Once the template vectors are regenerated, the system 106 recomputes similarity scores between a set of document pages and these regenerated template vectors. This recomputation ensures that document-template relationships are updated to reflect the improved template representations, particularly for pages sharing similar layouts and entity labels.

In one or mor embodiments, alongside template vector refinement, the system identifies and corrects any incorrect entity labels within the affected templates. The accuracy of entity labels is crucial for query mapping, making this correction process an essential component of template optimization. Through analysis of stored feedback and problematic pages, the system 106 systematically improves the accuracy of entity label assignments.

In one or more embodiments, the template optimization process integrates with a broader system improvement framework that leverages stored user feedback to enhance multiple aspects of text extraction and response generation. These improvements focus particularly on three critical areas: threshold adjustment, prompt refinement, and query mapping enhancement.

Within this improvement framework, the system 106 uses feedback patterns to make systematic adjustments to its processing parameters. These adjustments are driven by analysis of user feedback patterns and their correlation with template matching performance, ensuring that improvements are data-driven and targeted.

For instance, a key area of improvement involves adjusting the cosine similarity threshold for page selection. The system 106 modifies the cosine similarity threshold based on accumulated feedback, fine-tuning the criteria used to determine relevant document pages for query processing. This adjustment improves both precision and recall in page selection, ensuring appropriate pages are consistently identified based on their entity labels.

Another improvement area focuses on refining query-to-entity type mappings. By analyzing patterns in user feedback, the system 106 identifies and corrects cases where queries are consistently misaligned with entity types. These refinements improve the system's ability to understand user queries and map them to appropriate entity labels by modifying the entity label matching LLM prompt or the entity labels, ultimately leading to more accurate template selection and information extraction.

### EXAMPLE EMBODIMENT

Consider an example embodiment where a user queries the system 106 to extract specific information from an insurance policy document: “What is my deductible for property damage in this policy?”

The target document is a 50-page commercial insurance policy document containing various sections including “Policy Declarations,” “Coverage Details,” “Exclusions,” and “Endorsements.”

The receiving module 208 receives the user query and the uploaded insurance policy document. Prior to processing this specific query, it's important to understand that the system 106 has been configured through its template-based approach, with templates and entity labels established during the training phase.

The preprocessing module 210 has previously processed multiple insurance policy documents from various carriers and lines of business during its training phase to create templates. For each training document, the preprocessing module 210 performs page-level segmentation and applies a specialized token filter that removes all dynamic content (such as policyholder names, dates, policy numbers) while retaining insurance-specific terms, sentences, and descriptions. For example, when processing coverage declaration pages, terms like “deductible,” “coverage limit,” and “exclusions” are retained while specific amounts and entity names are filtered out. Pages of interest are manually identified, and entity labels are attached to describe the type of extractable information it contains.

The preprocessing module 210 then compares filtered content across similar pages from multiple training documents to identify truly static content. When analyzing multiple “Coverage Declaration” pages, the preprocessing module 210 identifies that certain terms, though insurance-specific, vary across policies and should be excluded from the template. The preprocessing module 210 then generates template vectors from this refined content, creating representations that capture page structure without dynamic elements.

The preprocessing module 210 associates each template with specific entity labels within the page layout. This association enables precise targeting of information during subsequent query processing.

Returning to the user's query, the preprocessing module 210 segments the 50-page target document into individual pages and applies the same domain-specific token filter to each page. The preprocessing module 210 generates vector representations of these filtered pages and performs similarity matching against stored templates.

The processing module 212 then performs similarity computations between these page vectors and the stored template vectors. In contrast to conventional RAG systems that typically achieve best similarity scores between 0.5 and 0.7, the present disclosure's filtered approach consistently achieves scores above 0.90 for matching pages. In this example, the processing module 212 identifies that page 12 of the target document matches the “Property Coverage Declarations” template with a similarity score of 0.98. The similarity score of 0.98 allows increasing the matching threshold to >0.9 which results in only most relevant pages getting selected as opposed to conventional RAG where threshold need to be kept low.

In some non-limiting embodiments, the “Property Coverage Declarations” template contains a “special processing label” that is applied for “vision based text extraction”, due to the historical tabular data extraction while using the default free extraction library. The preprocessing module 210 sends page 12 for the expensive vision based extraction process.

The response generation module 214 formulates the response by sending the user query and page 12 to the LLM: “Your property damage deductible is $1,000.” The module assigns this response a confidence score of 0.98, derived directly from the template matching score, and presents both to the user.

The example demonstrates how the present disclosure enables precise information extraction with significantly higher confidence than traditional methods. The high similarity scores are achieved through the removal of dynamic content before vector generation, allowing for exact template matching and targeted information extraction.

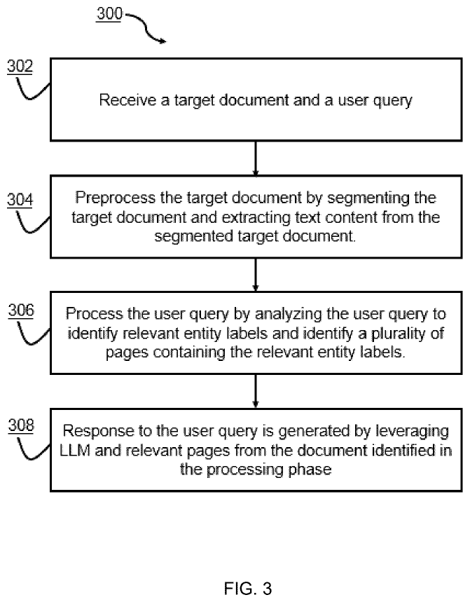

FIG. 3 is a diagram that illustrates a flowchart for a method for implementing a Retrieval-Augmented Generation (RAG) with improved context identification of from semi-structured documents, in accordance with an embodiment of the present disclosure.

At 302, a target document and a user query are received by the receiving module 208 to initiate the process of identification of relevant text from the target document. The target document could be a semi-structured stored in a local or remote data source, and the user query refers to a request for specific information or insights from the document.

At 304, the target document is preprocessed by the preprocessing module 210 by segmenting the target document, and extracting text content from the segmented target document. In one or more embodiments, segmentation involves dividing the target document into smaller, coherent sections or pages based on predefined criteria, such as page breaks, headings, or content structure. After segmentation, the preprocessing module 210 extracts the text content from each segment, isolating the textual data for analysis.

In one or more embodiments, extracting the text content from each individual page of the segmented target document involves processing the extracted text content through a domain-specific token filter to identify terms matching a stored domain-specific dictionary, and generate a filtered page content comprising the matching terms.

In one or more embodiments, the domain-specific dictionary is generated by analyzing the plurality of training documents using the LLM to identify domain-specific terms, aggregating the identified domain-specific terms, and storing the aggregated terms in the domain-specific dictionary.

In one or more embodiments, the plurality of training documents relevant to a specific domain are analyzed using the LLM to understand the context and content of the training documents, identifying terms and phrases that are frequently used within the domain.

Once the LLM identifies domain-specific terms from the training documents, the terms are aggregated to create a list. The aggregation process may include removing duplicates, normalizing variations of the same term (e.g., singular and plural forms), and ranking terms based on their relevance or frequency within the domain.

In one or more embodiments, the aggregated domain-specific terms are stored in a structured format within the domain-specific dictionary. The storage mechanism is configured to facilitate efficient lookups and integration with the token filtering processes. The dictionary may also be periodically updated or expanded as new training documents are analyzed or as the domain evolves.

In one or more embodiments, upon generating the filtered page content, a page vector representation of the filtered page content is computed by transforming the filtered text into a numerical representation that encapsulates the semantic meaning of the content. Document embedding techniques may be used to compute the page vector representation.

Thereafter, vector similarity computation is performed between the page vector representation and stored template vectors in a vector database by comparing the computed page vector with the template vectors to determine the degree of similarity between them. Techniques such as cosine similarity, Euclidean distance, or other similarity metrics may be employed to determine the degree of matching between document pages and stored templates, with each template vector being associated with predefined entity types via entity labels.

In one or more embodiments, each stored template vector is associated with predefined entity types via corresponding entity labels. The entity labels serve as metadata that categorically define the type of information or concept represented by the template vector. By linking template vectors to entity labels, the preprocessing module 210 establishes a structured relationship between the vector representations and their semantic meanings. This labeling approach enables precise mapping between document content and extractable information types, facilitating accurate information retrieval during query processing.

In one or more embodiments, the stored template vectors in the vector database are generated by receiving a plurality of training documents of a specific domain that follows common document structure. These training documents share consistent layouts, sections, and information organization patterns characteristic of the domain.

The training process begins with a user manually identifying important pages from the training documents. For each identified page, the user assigns entity labels that describe the types of information contained on that page. This manual selection and labeling process is crucial as it allows domain experts to indicate which pages contain valuable information and what type of information can be found on those pages.

The preprocessing module 210 segments each training document into individual pages. The segmentation process divides the training documents into discrete, manageable units, such as pages or sections, based on predefined criteria such as page breaks, headings, or logical content boundaries.

For each manually selected page, the preprocessing module 210 extracts the text content and processes it through a domain-specific token filter. This filtering process identifies terms that match a predefined domain-specific dictionary, retaining only the relevant domain-specific terminology while removing unnecessary text. The filtered content undergoes transformation using document embedding technique to create an initial template vector.

The initial template vector is then used to identify potential matching pages in subsequent training documents. Since these initial matches may contain dynamic content that varies between documents, the system presents a list of potential matching pages to the user. The user manually confirms which pages are correct matches, ensuring accurate template refinement.

Once matching pages are confirmed by the user, the preprocessing module 210 analyzes these pages to identify dynamic content that varies across instances while maintaining the same semantic meaning. By comparing multiple confirmed matching pages, the system identifies which content elements are dynamic (such as specific dates, names, or numerical values) versus static structural elements that remain consistent.

In one or more embodiments, after domain-specific filtering, the preprocessing module 210 may be configured to compute template vectors by retaining only the static structural elements and domain-specific terms, while removing the identified dynamic content. These template vectors, along with their user-assigned entity labels, are stored in the vector database. The entity labels serve as metadata, categorizing each template vector with specific, meaningful descriptors that define the type of information the vector represents.

In one or more embodiments, the preprocessing module 210 may be further configured to optimize the stored template vectors through an iterative process of identifying and removing dynamic content within the training pages. This optimization process begins with training pages that share the same entity labels previously assigned by the user during the manual training phase. By focusing on pages that the user has identified as functionally similar through their label assignments, the system ensures that the optimization occurs on truly comparable content.

In one or more embodiments, the preprocessing module 210 compares filtered content across these training pages that share user-assigned entity labels. Through this comparison, the system identifies dynamic content—terms or phrases that vary from page to page while maintaining the same semantic meaning. For example, in pages labeled as “policy declarations” by the user, elements such as policy numbers, dates, or monetary amounts would be identified as dynamic content since they change between documents while serving the same functional purpose.

By removing these identified dynamic content elements while preserving the static structural content and maintaining the user-assigned entity labels, the system creates more stable and accurate template representations. This selective removal process ensures that the templates retain their functional context while becoming more robust for matching operations.

Once dynamic content is identified and removed, the preprocessing module 210 regenerates the template vectors using only the retained static structural content. These regenerated template vectors, derived from content that has been filtered to exclude both non-domain-specific terms and dynamic content, provide more precise matching patterns. The optimization results in template vectors that better represent the essential structure and domain-specific elements of each document type, improving the accuracy of subsequent matching operation.

In one or more embodiments, the user query is analyzed to identify one or more relevant entity labels from a list of entity labels that are associated with the target document, which can answer the user query.

In one or more embodiments, upon performing vector similarity computation, the preprocessing module 210 extracts the entity labels from matched templates. The entity labels are then mapped to the corresponding document pages based on the computed similarity scores between the page vector representations and the stored template vectors.

In one or more embodiments, the similarity score for a page is determined by computing the cosine similarity between the filtered page vector representation of the target document and each stored template vector in the vector database. Cosine similarity measures the angular distance between two vectors in a multidimensional space, providing a numerical value that indicates how closely the vectors align.

For each filtered page vector representation, the preprocessing module 210 computes its cosine similarity with all available template vectors. Among the computed values, the highest cosine similarity value is selected as the similarity score for the page, which indicates the degree of alignment between the page's content and the closest matching template, reflecting how well the page's textual content corresponds to the predefined entity labels and structure of the template.

In one or more embodiments, individual pages requiring enhanced text extraction are identified based on their assigned entity labels. The system 106 determines which pages need enhanced processing by analyzing the special processing labels mapped during the template matching phase. This label-based approach ensures that specialized processing is applied based on the type of information expected on each page.

For the identified pages, the system applies label-specific extraction rules to refine the text content. These rules specify both the types of enhanced extraction techniques to be applied and the extraction parameters specific to each entity label. For example, pages labeled as containing tabular financial data might trigger specialized table extraction techniques, while pages labeled as containing policy endorsements might activate enhanced OCR settings optimized for complex layouts.

In one or more embodiments, the label-specific extraction rules are defined based on the characteristics and requirements of different entity types. These rules may specify various extraction parameters such as OCR sensitivity, parsing algorithms, or specialized filtering steps, each tailored to the specific type of information indicated by the entity label. The refined text content obtained through this enhanced extraction process maintains higher accuracy for complex document sections while optimizing processing resources by applying enhanced extraction only where needed based on entity labels.

In one or more embodiments, the label-specific extraction rules incorporate carrier-specific and line-of-business-specific processing requirements. For pages assigned specific pre-processing labels, the system applies these domain-specific rules to modify entity extraction prompts, adjust similarity thresholds, and select appropriate extraction techniques. For example, different insurance carriers may require specific extraction approaches for policy endorsements, or different lines of business may need specialized handling of coverage details.

At 306, the user query is processed by analyzing the user query to identify relevant entity labels and identify a plurality of pages containing the relevant entity labels. Upon receiving the user query, the processing module 212 utilizes the LLM to analyze the query and identify relevant entity labels associated with the user's intent from a list of all available entity labels in the document. The LLM is presented with the list of all available entity labels in the document and is enabled to identify a relevant entity label for the user query. Additionally, the processing module 212 identifies a matching template for the target document based on maximum number of pages matched during the vector similarity computation phase for establishing a template context for query processing.

In one or more embodiments, the processing module 212 retrieves all entity labels associated with the identified template. The processing module 212 then maps the user query against these retrieved entity labels using the LLM to determine which labels are specifically relevant for answering the query. Based on this mapping, the processing module 212 retrieves a plurality of pages from the document that contain these entity labels.

In one or more embodiments, applying domain-specific processing rules involves carrier-specific or line-of-business-specific rules for one or more of modifying entity extraction prompts, adjusting similarity thresholds, and selecting specific text extraction modules.

In one or more embodiments, the processing module 212 verifies whether at least one entity label and its corresponding page have been identified by the LLM. If no such identifier is made, the processing module 212 transitions to a fallback processing phase.

At 308, a response to the user query is generated by leveraging LLM and relevant pages from the document identified in the processing phase.

In one or more embodiments, a confidence score is computed to evaluate the closeness of the extracted page embedding to the matched template vectors. The confidence score is the cosine similarity score between the identified page and its matching template vector. Higher similarity scores reflect a stronger match between the page content and the expected structure, thereby enhancing confidence in the relevance of the extracted information.

In one or more embodiments, a confidence score is computed to evaluate the reliability and completeness of the extracted information. The confidence score is determined based primarily on the cosine similarity score between the page used for generating the final response and the corresponding template page with matching entity labels. This direct relationship between template matching and confidence scoring ensures that the score accurately reflects how well the source page aligns with established templates. The similarity scores, which measure how closely the identified pages align with the stored template vectors, contribute to the confidence score by indicating the accuracy of the page selection process. Higher similarity scores reflect a stronger match between the page content and the expected structure, thereby enhancing confidence in the relevance of the extracted information.

This score specifically reflects the strength of template matching, providing users with direct insight into the system's confidence in its template-based extraction process.

In one or more embodiments, the computed confidence score, along with the generated response, is presented to the user via the UI 104.

In some non-limiting embodiments, the confidence score is displayed as a numerical value, percentage, or a visual indicator, such as a color-coded bar or rating system, to intuitively convey the level of confidence in the generated response. For example, a high confidence score might be represented by a green indicator, while a lower score could be displayed in yellow or red, signaling potential gaps in the extracted information.

In one or more embodiments, feedback from the user is received to indicate the accuracy of the generated response. The system 106 facilitates this feedback process through the UI 104, which provides an interactive mechanism for users to evaluate the response. The user feedback received on the system's 106 accuracy will be used by the backend team to analyze domain term dictionary, created page templates, and applied entity labels to make necessary changes so that the right template is matched for the user query.

In one or more embodiments, when user feedback is received, the system 106 associates the feedback with multiple contextual elements, including the page vectors used for generating the response, the complete generated response text, and associated metadata such as timestamp and user identification.

In one or more embodiments, the confidence score is compared to a predefined confidence threshold for automatically triggering different response handling strategies. The predefined confidence threshold is dynamically adjustable and can be fine-tuned based on historical performance and domain-specific requirements.

In one or more embodiments, when the confidence score falls below the predetermined confidence threshold, the system 106 initiates a manual verification workflow. The manual verification workflow enables human oversight and validation for responses that the system 106 considers potentially uncertain or incomplete. A designated verifier is presented with the full context of the user query, including the generated response, and the specific document pages from which information was retrieved. The manual verification process allows for comprehensive review and potential correction of the system 106's output.

Once the verification input is received, it is stored within the system 106 for future use. The stored verification data can be leveraged to refine the system's 106 performance, for example, by retraining models, updating templates, or adjusting processing parameters. Over time, the manual feedback loop enhances the system's 106 ability to handle complex queries with higher accuracy, improving the overall robustness and reliability of the text extraction and response generation processes.

In one or more embodiments, patterns in stored user feedback are analyzed to identify template pages with consistent negative feedback. This analysis includes reviewing feedback data across various instances to detect recurring issues or discrepancies, particularly focusing on template matching accuracy and entity label correctness. Pages that receive repeated negative feedback are flagged for template optimization.

Once pages with consistent negative feedback are identified, they undergo detailed analysis to pinpoint dynamic content that may have been used for template vector representation. Dynamic content refers to any elements that vary across similar document pages, such as other context-dependent terms. Identifying these elements is crucial because such content can lead to inaccurate vector matching, affecting the overall quality of the similarity score. This analysis specifically targets content that varies across pages sharing the same entity labels and layout structure.

In one or more embodiments, after identifying the dynamic content, the next step involves removing these elements from the template vectors. The removal process ensures that the template vector representations accurately reflect the core, unchanging elements of the document while preserving the entity label associations. This refinement process is essential for maintaining template stability across different document instances.

Once the dynamic content is removed, the corresponding template vectors are regenerated in the vector database. The regeneration process allows the vector representations to reflect the updated and corrected content after the removal of dynamic elements. By reprocessing the template vectors, the system 106 optimizes its vector database for more accurate similarity matching, particularly focusing on maintaining consistent matching scores for pages with similar layouts and entity labels.

In one or more embodiments, the system 106 identifies and corrects any incorrect entity labels that were previously applied to the page templates. Entity labels are crucial for query mapping. By reviewing the stored feedback and analyzing the identified problematic pages, the system 106 makes necessary corrections to the entity labels.

In one or more embodiments, the stored user feedback is utilized to enhance the system's 106 performance by making adjustments to key components of the text extraction and response generation process. These adjustments focus particularly on improving template matching accuracy and entity extraction reliability.

The stored user feedback can be used for adjusting the predetermined threshold for page selection. The system 106 may modify the predefined threshold used to determine which document pages are relevant for a given query. Based on user feedback, the threshold can be fine-tuned to improve the precision and recall of the page selection process, ensuring that pages with appropriate entity labels are correctly identified and retrieved.

The method and system is advantageous in that it provides an improved Retrieval-Augmented Generation (RAG) process for semi-structured documents by enabling selective document section identification with reduced computational complexity. Specifically, the approach reduces processing overhead by accurately targeting relevant document sections, through improved document chunk retrieval accuracy, thereby minimizing unnecessary computational steps and improving overall system efficiency.

Furthermore, the method and system is advantageous through its introduction of domain-specific token filtering, which significantly improves the quality of vector matching. By reducing vector embeddings to contain only domain-specific information, the system achieves more accurate similarity matching. This is a crucial improvement over conventional approaches where large vectors containing domain-insignificant terms often result in false matches and lower similarity scores. The focused nature of these domain-filtered vectors enables more precise matching and higher similarity scores for truly relevant content.

Furthermore, the method and system is advantageous in the sense that it creates a vector database using training documents from a specific domain, where template vectors represent the consistent structural and contextual patterns of the document type. By introducing a training step into the RAG framework, the system enables improved accuracy by incorporating new documents into the training process, a capability not available in conventional RAG or similar approaches. Additionally, the use of template matching further enhances retrieval accuracy by allowing modifications to key components such as the domain keyword dictionary, entity labels, and conditional processing.

Additionally, the method and system is advantageous in that it introduces a confidence scoring method for verification of the accuracy of the response by calculating the relevance of the context (pages) that were used for arriving the response. The template matching process allows the relevance to be calculated between document pages and template vectors created during training phase. The approach transforms manual verification information into a quantifiable evaluation metric, enabling more precise relevance assessment of document chunks with reduced reliance on manual intervention.

Those skilled in the art will realize that the above-recognized advantages and other advantages described herein are merely exemplary and are not meant to be a complete rendering of all of the advantages of the various embodiments of the present disclosure.

In the foregoing complete specification, specific embodiments of the present disclosure have been described. However, one of ordinary skill in the art appreciates that various modifications and changes can be made without departing from the scope of the present disclosure. Accordingly, the specification and figures are to be regarded in an illustrative rather than a restrictive sense. All such modifications are intended to be included within the scope of the present disclosure.

What is claimed is:

1. A computer-implemented method for identifying relevant content from semi-structured documents, the method comprising:
receiving, by a processor, a target document and a user query to initiate text extraction operations from the target document;
preprocessing, by the processor, the target document by:
segmenting the target document into individual pages;
extracting text content from each individual page by:
processing the extracted text content through a domain-specific token filter to identify terms matching a stored domain-specific dictionary, and generate filtered page content comprising the matching terms;
computing, using an embedding model, a page vector representation of the filtered page content;
performing vector similarity computation between each page vector representation and stored template vectors in a vector database, wherein each stored template vector is associated with predefined entity types via entity labels;
extracting the entity labels from matched templates and mapping the entity labels to corresponding document pages based on similarity scores;
processing, by the processors the user query by:
analyzing, using a Large Language Model (LLM), the user query to identify relevant entity labels from the mapped document pages;
identifying one or more pages containing the relevant entity labels; and
generating, by the processor, a response to the user query using the LLM by sending the user query and the identified pages.

2. The method of claim 1, wherein the stored template vectors in the vector database are generated by:
receiving, by the processor, a plurality of training documents of a specific domain that follows common document structure;
receiving, by the processor, user input identifying specific pages from the training documents and corresponding entity labels describing information contained in the pages;
processing, by the processor, the identified pages through the domain-specific token filter;
identifying, by the processor, potential matching pages in additional training documents;
receiving, by the processor, user confirmation of correct matching pages;
analyzing, by the processor, the confirmed matching pages to identify dynamic content that vary between matching pages and static structural content that remains consistent;
generating, by the processor, refined template vectors by retaining the static structural content while removing the dynamic content; and
storing, by the processor, the refined template vectors and associated entity labels in the vector database.

3. The method of claim 2, wherein the domain-specific dictionary is generated by:
analyzing, by the processor, the plurality of training documents using the LLM to identify domain-specific terms;
aggregating, by the processor, the identified domain-specific terms; and
storing, by the processor, the aggregated terms in the domain-specific dictionary.

4. The method of claim 2, further comprising optimizing template vectors by:
comparing, by the processor, filtered content across multiple training pages having similar layouts and entity labels;
analyzing, by the processor, the compared pages to identify dynamic content that varies between pages while maintaining same semantic meaning;
identifying common patterns in the dynamic content specific to the document domain;
removing, by the processor, the identified dynamic content from the filtered training pages; and
regenerating, by the processor, the template vectors using only the static structural content from the filtered training pages.

5. The method of claim 1, further comprising:
determining, by the processor, pages requiring enhanced text extraction based on their assigned entity labels;
processing, by the processor, the determined pages using label-specific extraction rules, wherein the extraction rules specify types of enhanced extraction techniques to be applied, and extraction parameters specific to the entity label; and
obtaining, by the processor, refined text content based on the enhanced extraction.

6. The method of claim 1, wherein the vector similarity computation comprises:
computing, by the processor, a cosine similarity between each page vector representation and each stored template vector; and
determining, by the processor, similarity scores based on the highest cosine similarity values.

7. The method of claim 1, wherein analyzing the user query comprises:
identifying, by the processor, a matching template for the target document based on maximum number of pages matched during the vector similarity computation for establishing a template content for query processing;
retrieving, by the processor, all entity labels associated with the target document;
mapping, by the processor, using the LLM, the user query against the retrieved entity labels to identify labels relevant to answering the query; and
selecting, by the processor, pages from the target document having the identified relevant labels.

8. The method of claim 1, further comprising:
determining, by the processor, a confidence score for the generated response based on the cosine similarity score between the page used for response generation and the corresponding template page with matching entity labels;
displaying, by the processor, the confidence score with the generated response;
receiving, by the processor, user feedback indicating accuracy of the generated response;
storing, by the processor, the user feedback against the matched template for evaluating accuracy of template matching, and validating correctness of entity labels assigned to the template page; and
identifying, by the processor, templates requiring additional training based on confidence scores falling below a threshold value, or received negative user feedback.

9. The method of claim 8, further comprising:
comparing, by the processor, the confidence score to a confidence threshold;
responsive to determining that the confidence score is below the confidence threshold:
triggering, by the processor, a manual verification workflow;
receiving, by the processor, verification input through the manual verification workflow; and
storing, by the processor, the verification input for system improvement.

10. The method of claim 8, further comprising:
identifying, by the processor, patterns in the stored user feedback;
selecting, by the processor, template pages associated with consistent negative feedback;
analyzing, by the processor, the selected template pages by:
identifying and removing dynamic content that affects template vector representation;
regenerating template vectors in the vector database using the refined content and correcting entity labels assigned to the template pages; and
recomputing, by the processor, similarity scores between document pages and the regenerated template vectors.

11. The method of claim 8, further comprising:
adjusting, by the processor, based on the stored user feedback the threshold for similarity score computation, and query-to-entity label mappings.

12. The method of claim 5, wherein the label-specific extraction rules comprise:
domain-specific processing rules determined based on the entity labels, wherein for pages assigned specific entity labels: applying carrier-specific or line-of-business-specific rules to adjust similarity thresholds, and select specific extraction techniques.

13. The method of claim 1, further comprising:
determining, by the processor, whether at least one entity label is identified for the user query;
responsive to determining that one or more required entity labels are not obtained:
computing, by the processor, a full-content vector representation of each page;
performing, by the processor, a secondary vector similarity search of the vectorized user query against the full-content vector representations; and
identifying, by the processor, additional relevant pages based on the secondary search.

14. A system for identifying relevant text from semi-structured documents, the system comprising:
a processor;
a memory storing instructions that, when executed by the processor, cause the processor to:
receive a target document and a user query to initiate text extraction operations from the target document;
preprocess the target document by:
segmenting the target document into individual pages;
extracting text content from each individual page by: process the extracted text content through a domain-specific token filter to identify terms matching a stored domain-specific dictionary, and generate filtered page content comprising the matching terms;
computing, using an embedding model, a page vector representation of the filtered page content;
performing vector similarity computation between each page vector representation and stored template vectors in a vector database, wherein each stored template vector is associated with predefined entity types via entity labels;
extracting the entity labels from matched template and map the entity labels to corresponding document pages based on similarity scores;
process the user query by:
analyzing, using a Large Language Model (LLM), the user query to identify relevant entity labels from the mapped document pages;
identifying one or more pages containing the relevant entity labels; and
generate a response to the user query by calling LLM with the user query and identified pages.

15. The system of claim 14, wherein the memory stores further instructions that cause the processor to generate the stored template vectors by:
receiving, by the processor, a plurality of training documents of a specific domain that follows common document structure;
receiving, by the processor, user input identifying specific pages from the training documents and corresponding entity labels describing information contained in the pages;
processing, by the processor, the identified pages through the domain-specific token filter;
identifying, by the processor, potential matching pages in additional training documents;
receiving, by the processor, user confirmation of correct matching pages;
analyzing, by the processor, the confirmed matching pages to identify dynamic content that vary between matching pages and static structural content that remains consistent;
generating, by the processor, refined template vectors by retaining the static structural content while removing the dynamic content; and
storing, by the processor, the refined template vectors and associated entity labels in the vector database.

16. The system of claim 15, wherein the memory stores further instructions that cause the processor to generate the domain-specific dictionary by:
analyzing the plurality of training documents using the LLM to identify domain-specific terms;
aggregating the identified domain-specific terms; and
storing the aggregated terms in the domain-specific dictionary.

17. The system of claim 15, wherein the memory stores further instructions that cause the processor to optimize template vectors by:
comparing filtered content across multiple training pages having similar layouts and entity labels;
analyzing, by the processor, the compared pages to identify dynamic content that varies between pages while maintaining same semantic meaning;
identifying common patterns in the dynamic content specific to the document domain;
removing, by the processor, the identified dynamic content from the filtered training pages; and
regenerating, by the processor, the template vectors using only the static structural content from the filtered training pages.

18. The system of claim 14, wherein the memory stores further instructions that cause the processor to:
determine pages requiring enhanced text extraction based on their assigned entity labels;
process the determined pages using label-specific extraction rules, wherein the extraction rules specify types of enhanced extraction techniques to be applied, and extraction parameters specific to the entity label; and
obtain refined text content based on the enhanced extraction.

19. The system of claim 14, wherein the memory stores further instructions that cause the processor to perform the vector similarity computation by:
computing a cosine similarity between each page vector representation and each stored template vector; and
determining similarity scores based on the highest cosine similarity values.

20. The system of claim 14, wherein the memory stores further instructions that cause the processor to analyze the user query by:
identifying a matching template for the target document based on maximum number of pages matched during the vector similarity computation for establishing a template content for query processing;
retrieving all entity labels associated with the target document;
mapping, using the LLM, the user query against the retrieved entity labels to identify labels relevant to answering the query; and
selecting pages from the target document having the identified relevant labels.

21. The system of claim 14, wherein the memory stores further instructions that cause the processor to:
determine a confidence score for the generated response based on the cosine similarity score between the page used for response generation and the corresponding template page with matching entity labels;
display the confidence score with the generated response;
receive user feedback indicating accuracy of the generated response;
store the user feedback against the matched template page for evaluating accuracy of template matching, and validating correctness of entity labels assigned to the template page; and
identify templates requiring additional training based on confidence scores falling below a threshold value, or received negative user feedback.

22. The system of claim 21, wherein the memory stores further instructions that cause the processor to:
compare the confidence score to a confidence threshold;
responsive to determining that the confidence score is below the confidence threshold:
trigger a manual verification workflow;
receive verification input through the manual verification workflow; and
store the verification input for system improvement.

23. The system of claim 21, wherein the memory stores further instructions that cause the processor to:
identify patterns in the stored user feedback;
select template pages associated with consistent negative feedback;
analyze the selected template pages by:
identifying and removing dynamic content that affects template vector representation;
regenerating template vectors in the vector database using the refined content and correcting entity labels assigned to the template pages; and
recompute similarity scores between document pages and the regenerated template vectors.

24. The system of claim 21, wherein the memory stores further instructions that cause the processor to:
adjust, based on the stored user feedback, the threshold for similarity score computation, and query-to-entity label mappings.

25. The system of claim 18, wherein the label-specific extraction rules comprise:
domain-specific processing rules determined based on the entity labels, wherein for pages assigned specific entity labels applying carrier-specific or line-of-business-specific rules to adjust similarity thresholds, and select specific extraction techniques.

26. The system of claim 14, wherein the memory stores further instructions that cause the processor to:
determine whether at least one entity label is identified for the user query;
responsive to determining that one or more required entity labels are not obtained:
compute a full-content vector representation of each page;
perform a secondary vector similarity search of a vectorized user query against the full-content vector representations; and
identify additional relevant pages based on the secondary search.
